(19) United States
(12) Patent Application Publication
(10) Pub. No.: US 2010/0274385 A1
(43) Pub. Date: Oct. 28, 2010

(54) CONTROL SYSTEM FOR CONTROLLING AN INDUSTRIAL ROBOT

(75) Inventor: Peter J. Eriksson, Västerås (SE)

Correspondence Address: BUCHANAN, INGERSOLL & ROONEY PC, POST OFFICE BOX 1404, ALEXANDRIA, VA, 22313-1404, US

(73) Assignee: ABB Technology AB, Västerås (SE)

(21) Appl. No.: 12/305,090

(22) PCT Filed: Jan. 18, 2008
(86) PCT No.: PCT/EP2008/050552

§ 371 Date: Dec. 16, 2008

(51) Int. Cl. B25J 9/16; G06F 9/50; G05B 19/414

(52) U.S. Cl. 700/245

(57) ABSTRACT

A control system for controlling at least one industrial robot, wherein the control system comprises a plurality of software modules (41-47) for handling various system functions of the control system, and a plurality of separate hardware units (50-53), each comprising a processing unit (30a-d) and a memory unit (26a-d) for storing one or more of said software modules, and each of the hardware units is configured to receive and execute one or more of the software modules. At least some of the software modules are arranged scalable with regard to the performance of the system functions dependent on the capacity of the hardware unit running the software module, and the control system comprises a resource-distributing unit (55) having knowledge of the capacity of the hardware units, the scalability of the software modules, and the demand on hardware capacity of the software modules, and the resource-distributing unit is configured to plan how to distribute said software modules among said hardware units in order to optimized the performance of the system functions.

### TECHNICAL FIELD

The present invention relates to a control system for controlling at least one industrial robot, wherein the control system comprises a plurality of software modules for handling various system functions of the control system, and a plurality of separate hardware units, each comprising a processing unit and a memory unit for storing one or more of said software modules, and each of the hardware units is configured to receive and execute one or more of the software modules.

### BACKGROUND ART

An industrial robot comprises a manipulator and a control system for controlling the movements of the manipulator. A manipulator is a movable mechanical unit, the movements of which are driven by one or more motors. Traditionally, the control system of an industrial robot comprises a stationary control device including a main control unit, a servo control unit providing the motors with current, and a handheld control device. The stationary control device comprises hardware, such as a CPU and program memory for storing robot programs including movement instructions for the robot, and software for executing the movement instructions, for planning robot paths based on the movement instructions, and for generating control signals to the servo control unit. The handheld control device comprises hardware, such as a CPU and memory, and software, such as software for providing a user interface to the control device and for communicating with the main control unit. The servo controller also includes hardware, such as a CPU and memory, and software for carrying out the servo control.

One disadvantage of control system today is that they are inflexible. If it is desired, for example, to add a new function or replace some part of the control system, it is necessary to intervene and make changes in the existing control system. For instance, the existing control system must either be oversized from the start regarding computer utility and power supply, or the whole of or parts of the control system must be replaced or be rebuilt to obtain the necessary computer utility and power supply. Another disadvantage with the control systems of today is that available hardware is seldom used in an optimal manner.

EP 0 318 601 discloses an apparatus for controlling an industrial robot comprising a plurality of arithmetic and control units, each comprising a processor, connected to each other through a common bus and sharing the control of the industrial robot, an external storage unit connected to the arithmetic and control units for storing an operating system and a plurality of tasks operated in each of the arithmetic and control units, management data for assigning tasks to the arithmetic and control units, a shared memory connected to the plurality of arithmetic and control units and to the external storage unit, and I/O boards. The apparatus is connected to a drive section via the I/O boards. At a start up of the industrial robot control apparatus, each of the arithmetic and control units loads data stored in the external storage unit into an own memory by using an initial loader operation in response to an energization of a power source. Thus, it is possible to automatically and optimally distribute the software for controlling the robot in response to the ability of a plurality of processors and thereby to optimize the available computer capacity. However, this is a traditional multi-CPU solution with a fixed number of CPU:s. A disadvantage with this system is that it is inflexible, and it is difficult to add a new function or replace some part of the control system.

### SUMMARY OF THE INVENTION

The aim of the invention is to provide an improved control system for an industrial robot, which uses the available hardware in an optimal manner.

This object is achieved by a control system as defined by claim 1.

Such a control system is characterized in that at least some of the software modules are arranged scalable with regard to the performance of the system functions dependent on the capacity of the hardware unit running the software module, and the control system comprises a resource-distributing unit having knowledge of the capacity of the hardware units, the scalability of the software modules and their demand on hardware capacity, and configured to plan how to distribute said software modules among said hardware units in order to optimize the performance of the system functions.

The software modules are not bound to any particular hardware unit. Because each hardware unit is adapted to receive and run each software module it is made possible to freely select any of the hardware units to host a specific function of the control system, by downloading the software module into the selected hardware unit. It is also possible to load two or more software modules to one hardware unit.

Each software module is adapted to perform a function of the control system. With a system function is meant any function carried out by the control system, such as servo control, path planning, safety functions, communication, I/O-handling, user interface, process control, and language handling. A scalable software module is adapted to perform its system function with different degrees of performance, for example with different degrees of accuracy, quality and/or quantity, in dependence on the capacity, for example computing power and memory storage, of the hardware unit hosting and running the software module. Thus, the performance of the system function performed by the module is dependent on the capacity of the hardware unit hosting it. An advantage with scalable software modules is that they can utilize the available hardware in an optimal manner. Further, if it is a desire, the performance of a certain system function can easy be increased by moving the software module to another hardware unit with more available capacity, or if there is more than two software modules on the same hardware unit, by moving the other software module to another hardware unit with available capacity. Such a control system is very flexible. It is easy to add new hardware units in order to increase the hardware capacity of the control system, and thereby to increase the performance of the system functions.

The resource-distributing unit has knowledge of the capacity of the hardware units and the demand on hardware capacity of the software modules, and is configured to plan how to distribute the software modules among the hardware units in order to optimize the performance of the system functions. In order to be able to optimize the performance of the control system, the resource-distributing unit must also have knowledge of the scalability of the software modules, i.e. how much performance the module can provide in dependence on how much hardware capacity it gets, for example, the number of performance levels provided by the software module and the hardware capacity required by each level. The recourse-distributing unit considers the scalability of the software modules and distributes the software modules such that the performances of the system functions are optimized. Thus, the hardware of the control system is utilized in an optimal manner. The invention makes it possible to optimize the performance of control system regarding the quality as well as quantity by distributing the software modules on the hardware units in an optimized way. Thereby a completely flexible control system is achieved.

According to an embodiment of the invention, the control system comprises an internal network. Each of said hardware units is arranged as a node in the internal network, and each hardware unit comprises a communication unit for communicating with all the other nodes in the internal network. By connecting the hardware units to an internal network, instead of a bus as in the prior art, it is possible for each hardware unit to communicate directly with all the other modules, regardless of where the modules are placed physically relative to each other. Further because the functions of the control system has been divided into a plurality of software modules loaded onto separate hardware units connected to and adapted to communicate with each other over a internal network it is made possible to add or remove capacity and/or a function of the control system by connecting or disconnecting a hardware unit to or from the internal network. Thereby it is possible to adapt the performance and functionality of the control system depending on the current application.

For example, the resource-distributing unit is configured to plan how to distribute said software modules upon a user request. Alternatively, the resource-distributing unit can be configured to automatically plan how to distribute the software modules when detecting that a change has been made to the hardware units, such as an addition of or removal of a hardware unit.

According to an embodiment of the invention, at least one of said hardware units comprises a persistent data storage for storing software modules adapted to handle various functions of the control system. Preferably, all of the hardware units comprises a persistent data storage. A persistent data storage is a data memory that keeps its content in spite of the power is turned off, for example, a memory card, a hard drive or a non-volatile memory. As each hardware unit is provided with a persistent data storage, it is possible to load the software modules to the data storage at request and at any time. It is not necessary to reload the software modules each time the robot starts up, and therefore the shared memory in the prior art can be omitted. Preferably, the robot supplier loads the software module to the data storage of the hardware units before delivery to the customer. After that, it is only necessary to load new software modules upon reconfiguration of the control system, for example, when a new function is added to the system, or a new hardware unit is added to or removed from the system.

According to an embodiment of the invention, the scalable software modules have been assigned different priorities and the resource-distributing unit is configured to plan how to distribute the software modules based on their priorities. This embodiment makes it possible to set different priorities to different system functions, and thereby enabling high performance of selected system functions, which are given a high priority. For example, if a smooth path is desired the path planner function is assigned a high priority.

According to an embodiment of the invention, the software modules are scalable in two or more consecutive scaling steps, each scaling step having a defined demand on hardware capacity, and each subsequent step having an increased demand on the capacity of the hardware unit, and the software modules provides an increased performance of their system function for each subsequent step. This embodiment makes it easy for the resource-distributing unit to match the software modules with the hardware units in an optimal manner.

According to an embodiment of the invention, the system also comprises at least one non-scalable software module. For example, the system may comprise a non-scalable software module for handling safety functions of the robot. The safety functions of the robot control system are so important that they must always have a high performance. Therefore, it is should not be allowed to change the performance of the safety functions.

According to an embodiment of the invention at least one of the hardware units is adapted to receive and run a software module for a special purpose and the hardware unit comprises special hardware for that purpose. Some of the special software modules demand special hardware, for instance: a display, a sensor, an HMI, a digital/analog converter, a digital transmitter. This is advantageous when a function of the control system needs input or supervision automatically or by an operator, or if the process run by the control system needs a transmitted input signal. This embodiment is further advantageous since the same concept with separate software and hardware units can be used also for system functionality that requires special hardware. Despite the fact that the hardware unit is adapted to receive the special software module it is still adapted to receive any other software module which is not requiring any special hardware. When a hardware unit comprising a special hardware is not in use with a special software module, the hardware unit can also be utilized for software modules not requiring any special hardware.

### BRIEF DESCRIPTION OF THE DRAWINGS

The present invention will be described in more detail in connection with the enclosed schematic drawings.

FIG. 1 shows a conventional industrial robot 1 comprising a manipulator and a control system,

FIG. 2 shows an example of hardware of a control system according to the invention, and

FIG. 3 shows an example a control system according to the invention.

FIG. 4 shows an example of a configuration of a control system according to the invention.

FIG. 5 shows another example of a configuration of a control system according to the invention.

### DESCRIPTION OF THE PREFERRED EMBODIMENTS

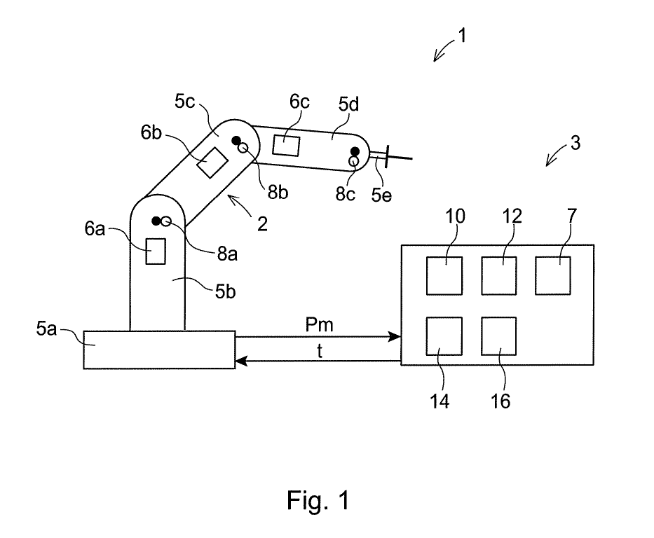

FIG. 1 shows a conventional industrial robot 1 comprising a manipulator 2 and a control system 3. The industrial robot 1 has a plurality of robot parts rotatably movable relative to each other. The robot parts are in this case a stand 5a, robot arms 5b-d, and a tool holder 5e. The industrial robot comprises a plurality of actuators 6a-c for controlling the position and speed of the robot parts. The actuators are connected to a servo control unit 7 for generating control signals to the motor and located in the control system 3. The manipulator is also provided with sensors 8a-c detecting the position of the robot parts. Signals comprising measured data Pm from the sensors 8a-c are transmitted to the control system 3. The measured data comprises, for instance, angular position, velocity, and acceleration.

The control system 3 comprises a main computer unit 10, a memory unit 12 for storing control programs including movement instructions for the robot, a program executor unit 14 for executing the movement instructions, and a path planner unit 16. The path planner unit 16 is planning the robot paths and further generating torque reference signals to the drive unit 7 based on the movement instructions from the robot program and a mathematical model of the robot. During operation of the robot, the program instructions are executed, thereby making the robot work as desired. The drive unit 7 controls the motors by controlling the motor torques and the motor positions in response to the reference values from the path planner unit 16. The drive unit 7 generates control signals T to the motors of the robot.

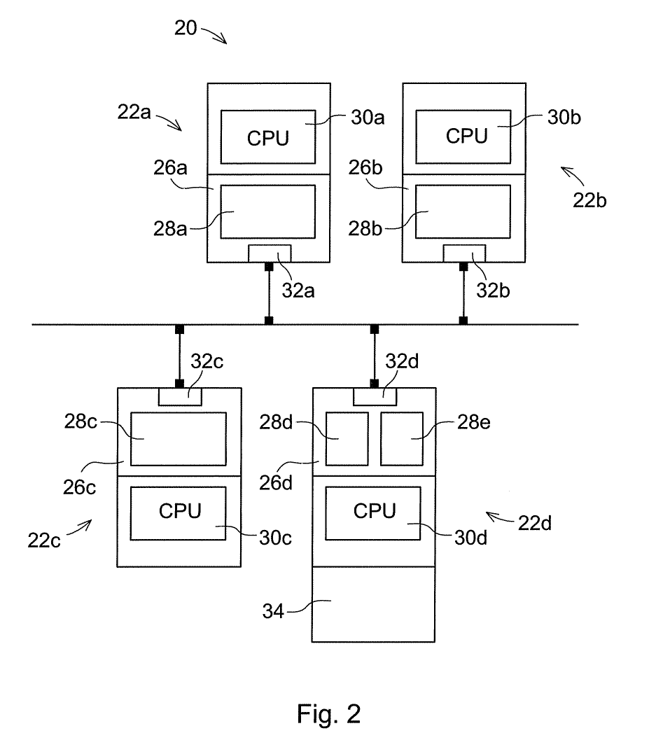

FIG. 2 schematically shows hardware units of a control system 20 according to an embodiment of the invention. The control system 20 is adapted for controlling an industrial robot including a manipulator. The control system comprises an internal communication network 21. The communication network may be wired or wireless, of Ethernet type or the like. The control system 20 in this case also comprises four separate hardware units 22a-d. Each hardware unit is separately connected to the internal network 21 and thereby arranged as a node in the internal network. Each hardware unit 22a-d forms a unique node in the internal network. Each hardware unit 22a-d includes a memory unit 26a-d adapted to receive one or more software modules 28a-d, a processing unit 30a-d, such as a Central Processing Unit (CPU), adapted to run the software modules 28a-d and a communication unit 32a-d adapted for communicating with the other hardware units over the internal network. At least one of the memory units 26a-d is a persistent data storages such as a memory card, a hard drive or a non-volatile memory. In one embodiment of the invention each hardware unit is provided with persistent data storage. In another embodiment only one of the memory units is provided with persistent data storage. For example, the other hardware units are adapted to retrieve the software units from the hardware unit with the persistent data storage. The communication units 32a-d are adapted to send and receive data packages via the internal network. The electronics of the internal network also comprises a switch for controlling transfer of data packages between the nodes of the internal network. The communication units include, for example, a Network Interface Card (NIC). Each of the hardware units is adapted to receive, store and execute one or more software modules. The capacity of the hardware units, for example regarding computing power and memory capacity, can be equal for all hardware units in one embodiment and differ between the hardware units in another embodiment.

The software modules 28a-d are adapted to handle various functions of the control system 20. The software modules are, for example, a path planner configured to plan the movements of the robot based on the robot programs, one or more servo control modules configured to control the motors driving the movements of the manipulator, a safety module configured to carry out safety functions of the robot, a communication module configured to handle the internal communication in the control system, a language module configured to translate robot language into low level language, one or more process control modules for controlling a process, such as generating control signals to process equipment, for example welding equipment, and an I/O module handling I/O signals of the control system, such as to receive and send signals. The software modules 28a-d are transmitted through the internal network and loaded to the hardware units. The main computer unit comprises a logic unit or computing unit comprising a microprocessor, or processors comprising a central processing unit (CPU) or a field-programmable gate array (FPGA) or any semiconductor device containing programmable logic components and programmable interconnects for performing the steps in a computer program.

The hardware units may also be adapted to receive and run a software module for a special purpose, which needs special hardware for that purpose. The hardware units may include that special hardware. In FIG. 2 the software module 28d is such special software. In this case the hardware unit 22d comprises special hardware 34. For example, the software module is an HMI module for teaching and programming the robot. This module requires special hardware such as a display unit, an enabling device and an emergency stop button. The special hardware required is, for example, gathered, in a separate hardware unit 34 which is connected to the hardware unit 22d. A hardware unit including special hardware can also be loaded with other software modules 28e adapted to carry out other functions.

A plurality of different types of software modules is available and each type of module has its own function. Each of the software modules is adapted to independently manage a specific function for the control system. When the modules are interconnected, they form a control system with all the functions of a conventional control system. The control system composed of the separate modules need not include all types of modules and may include several modules of the same type. For instance, a servo control module can be configured to control one motor driving one axis of the manipulator. Accordingly, one servo control module is needed for each axis of the manipulator. A manipulator of an industrial robot commonly includes 4-6 axes. The robot control system may also control one or more external axis. In this case a plurality of servo control modules is needed. In another embodiment of the invention, a servo control module is configured to control all motors of one manipulator. However, if the control system controls a plurality of manipulators more than one servo control module is needed.

When one hardware unit communicates with another hardware unit via the communication units 32a-d, the communication units 32a-d have information on the functionality of each software module 28a-d in the control system and in which node each software module is located, i.e. in which hardware unit, and thereby which hardware unit to communicate with for every step in a current application run by the control system.

Each of the hardware units 22a-d is replaceable with a new hardware unit adapted to receive and run a new software module 28a-d with a new, an extended or reduced functionality. The hardware units 22a-d are further adapted to receive or transmit software modules over the internal network 20. The software modules 28a-d are movable between the hardware units 22a-d connected to the internal network 20. This is done by moving the software model between the memory units of the hardware units. This is done, for instance, when a control system has to be changed to perform another task, for instance when a manipulator is connected or disconnected from the control system or performs a less complex or more complex application.

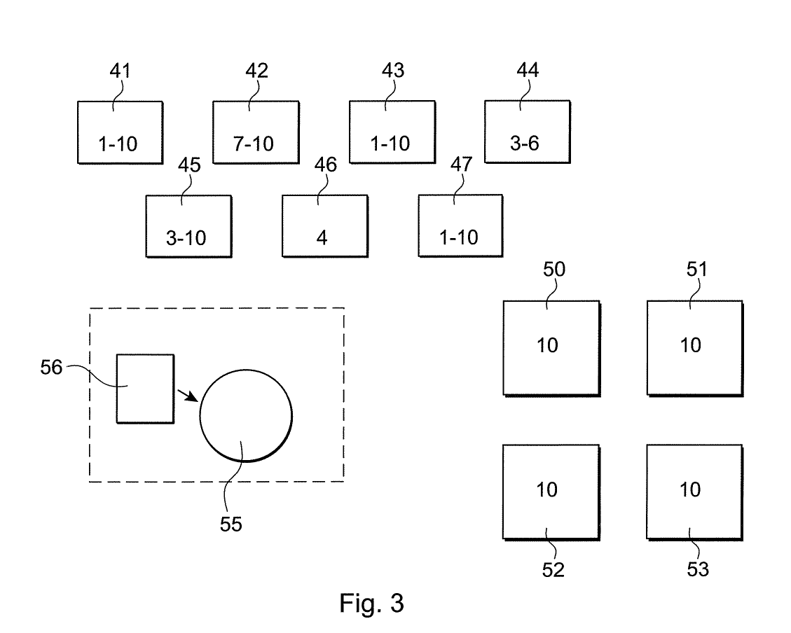

FIG. 3 shows an example of a control system according to the invention. The control system comprises a plurality of software modules 41-47 for handling various system functions of the control system, and a plurality of separate hardware units 50-53, each comprising a processing unit, a memory unit for storing one or more of said software modules and a communication unit for communicating with the other hardware units on an internal network. Each of the hardware units is configured to receive and execute one or more of the software modules. The hardware units in this embodiment have the same capacity regarding computing power and memory storage. The capacity of each hardware unit is 10 units. Each software module requires a minimum amount of hardware capacity in order to be able to execute its function. Some of the software modules are arranged scalable with regard to the performance of the system functions dependent on the capacity of the hardware unit running the software module. This means that the performance of the software module depends on the capacity of the hardware unit hosting and running it. If more than one software module is hosted on the same hardware unit, the performance of the software module depends on how much of the capacity of the hardware unit the software unit has been assigned.

The software modules are scalable in discrete steps. The first step requires a minimum amount of hardware capacity in order to be able to execute the defined system function of the module. Each further step requires hardware capacity of 1 unit. For example, software modules 41,43,47 are scalable in 10 discrete steps, each step requiring a hardware capacity of 1 unit. The software modules 41,43,47 are, for example, a communication module, a process control module and an I/O-module. The performance of the communication module is scalable with regard to its capacity to handle communication load and the quality of the communication. The performance of the process control module is scalable with regard to . . . (ge exempel . . . ). The performance of the I/O-module is scalable with regard to the number of input and output signals to be handled, and the resolution and accuracy of the signals.

Software module 42 is scalable in four steps. The first step requires hardware capacity of 7 units, each further step requiring a hardware capacity of 1 unit. Software module 42 is, for example, a path planner. The system function of the path planner is to plan a robot path and to determine the movements of the axes of the manipulator in order to follow the path. The performance of the path planner module is, for example, scalable with regard to the smoothness of the planned path.

Software module 44 is scalable in four steps. The first step requires a hardware capacity of 3 units, each further step requires a hardware capacity of 1 unit. Software module 44 is, for example, a language module. The performance of the language module is scalable with regard to the number of calculations performed per time unit and/or the number of programs that can be executed in parallel. Software module 45 is scalable in eight steps. The first step requires a hardware capacity of 3 units, each further step requires a hardware capacity of 1 unit. Software module 45 is, for example, a servo control module configured to control the motors of the robot. The performance of the servo control module is scalable with regard to the number of motors of the manipulator. Software module 46 is not scalable and requires a hardware capacity of 4 units. Software module 46 is, for example a safety module.

The control system further includes a resource-distributing unit 55 adapted to find an optimised distribution of the software modules on the hardware units. The resource-distributing unit decides for each software module on which hardware unit it shall be stored and executed, and also how much of the hardware capacity of the hardware unit the software module is allowed to use.

The resource-distributing unit 55 has knowledge of the capacity of the hardware units, i.e. the number of capacity units provided by the hardware unit, and the demand on hardware capacity of the software modules, i.e. the number of capacity units required by the software module in order to be able to run it. The resource-distributing unit 55 also has knowledge of the scalability of the software modules, i.e. the number of scaling steps and the extra hardware capacity required by each step. The resource-distributing unit is configured to plan how to distribute the software modules among the hardware units in order to optimize the performance of the system functions. How to distribute the software modules among the hardware units is decided automatically by means of an optimization algorithm, such as a best-fit mathematical optimization algorithm.

The resource-distributing unit, including the optimization algorithm, is a software module and can be stored and run on any of the hardware units of the control unit or on an external computer. If a new software module is to be added to the control unit or any of the software modules is changed, the optimization algorithm is run again in order to find an optimal distribution of the software modules of the hardware units. During the optimization, the optimization algorithm considers the scalability of the software modules and tries to find a distribution that maximizes the performance of the software modules. The distribution of the software to the hardware units can be done either manually or automatically. For example, it is advantageous if the resource-distributing unit is configured to automatically carry out the distribution of the software modules when the execution of the optimization algorithm has been finished. Preferably, the resource-distributing unit is configured to plan how to distribute the software modules, and optionally to distribute the software modules upon a user request. For example, the robot operator can be allowed to start execution of the resource-distributing unit.

During the optimization, it may appear many possibilities how to distribute the software modules. In an embodiment of the invention, the scalable software modules are assigned different priorities and the source-distributing unit is configured to plan how to distribute said software modules based on their priorities. The priorities of the scalable software modules are for example stored in a memory 56. This embodiment makes it possible to prioritize the performance of the software modules. The priorities can either be set by an operator or be predefined by the robot manufacturer.

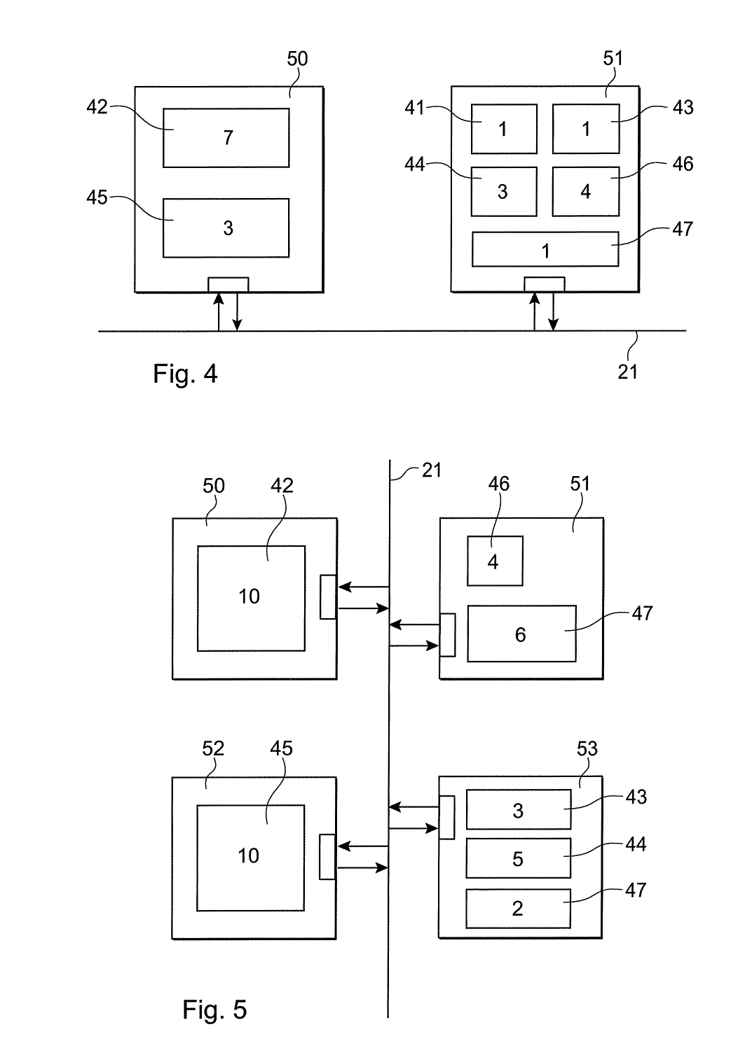

FIG. 4 shows one possibility to configure the control system of FIG. 3. In this application only two hardware units 50,51 are used. The hardware modules are connected to an internal network 21. The software modules 41-47 are distributed such that hardware unit 50 hosts software modules 42 and 45 and hardware unit 51 hosts software modules 41, 43, 44, 46, and 47. Hardware unit 50 provides a hardware capacity of 10 units. Software module 42 has a minimum requirement on hardware capacity of 7 units, and software module 45 has a minimum requirement on hardware capacity of 3 units. This means that software modules 42 and 45 can be run on hardware unit 50 if they are scaled at their lowest performance level, i.e. 7+3=10. Hardware unit 51 also provides a hardware capacity of 10 units and has capacity enough to run the remaining software modules if they are all scaled to their lowest performance level, i.e. 1+1+3+4+1=10.

If a higher performance of the control system is desired, more hardware modules must be connected to the internal network 21. FIG. 5 shows another possibility to configure the control system of FIG. 3. In this application four hardware units 50-53 are connected to the internal network 21. This provides many possibilities to distribute the software modules. In this case the software modules 42 and 45 have been given highest possible priority, which means that it is desired that their maximum capacity are used. In order to be able to provide their maximum capacity, each of the software modules 42 and 45 requires hardware capacity of 10 units. Accordingly, each of the software modules 42 and 45 is hosed alone in one of the hardware units 50,52. Software modules 41 and 46 are hosted in hardware unit 51. As software module 46 is not scalable and requires 4 hardware capacity units, the software module 41 can use 6 capacity units and thereby provide a considerably higher performance than in the application shown in FIG. 4, in which it only uses 1 capacity unit. Software modules 43, 44 and 47 are hosted in hardware unit 53. Software module 43 has been assigned 3 capacity units, software module 44 has been assigned 5 capacity units, and software module 47 has been assigned 3 capacity units. This means that all of the software modules 43, 44 and 47 have increased their performance compared to the application shown in FIG. 4.

The invention is not limited to the embodiments shown but may be varied and modified within the scope of the appended claims. The division of the modules with respect to what functions they are to handle may be done in other ways than those shown in the above-described embodiments. The number of different types of software modules may also vary. The principle for the division of the functions of the control system into different modules is that these functions are divided in such a way as to require as small an exchange of information between the modules as possible. Further, the number of hardware modules may vary between different applications.

1. A control system for controlling at least one industrial robot, wherein the control system comprises a plurality of software modules for handling various system functions of the control system, and a plurality of separate hardware units, each comprising a processing unit and a memory unit for storing one or more of said software modules, and each of the hardware units is configured to receive and execute one or more of the software modules, wherein at least some of the software modules are arranged scalable with regard to the performance of the system functions dependent on the capacity of the hardware unit running the software module, and the control system comprises a resource-distributing unit having knowledge of the capacity of the hardware units, the scalability of the software modules, and the demand on hardware capacity of the software modules, and the resource-distributing unit is configured to plan how to distribute said software modules among said hardware units in order to optimize the performance of the system functions.

2. The control system according to claim 1, wherein at least one of said memory unit for storing one or more software modules is a persistent data storage.

3. The control system according to claim 1, wherein the resource-distributing unit is configured to plan how to distribute said software modules upon a user request.

4. The control system according to claim 1, wherein the scalable software modules have been assigned different priorities and the source-distributing unit is configured to plan how to distribute said software modules based on their priorities.

5. The control system according to claim 1, wherein the software modules are scalable in two or more consecutive scaling steps, each scaling step having a defined demand on hardware capacity, and each subsequent step having an increased demand on the capacity of the hardware unit, and the software modules provides an increased performance of their system function for each subsequent step.

6. The control system according to claim 1, wherein the system comprises at least one non-scalable software module.

7. The control system according to claim 6, wherein said non-scalable software module is configured for handling safety functions of the robot.

8. The control system according to claim 1, wherein the system comprises a scalable software module for servo control of motors of the robot.

9. The control system according to claim 1, wherein the system comprises a scalable software module for handling path planning of the robot.

10. The control system according to claim 1, wherein the system comprises a scalable software module for handling I/O-signals of the system.

11. The control system according to claim 1, wherein the control system comprises a internal network, and each of said hardware units is arranged as a node in the internal network and each hardware unit comprises a communication unit for communicating with all the other nodes in the internal network.
